(19) United States
(12) Patent Application Publication
(10) Pub. No.: US 2014/0218926 A1
(43) Pub. Date: Aug. 7, 2014

(54) Illuminated Light Effect Ornament

(71) Applicant: Nicholas Jackson, Oak Forest, IL (US)

(72) Inventor: Nicholas Jackson, Oak Forest, IL (US)

(21) Appl. No.: 13/756,722

(22) Filed: Feb. 1, 2013

(51) Int. Cl. F21S 4/00

(52) U.S. Cl. CPC F21S 4/00
USPC 362/249.16

(57) ABSTRACT

A hollow illuminated ornament housing a plurality of light strings controlled by electronics providing lighting effects communicated to the light bulbs which extend through the exterior surface of the shell. The ornament, in any configured shape, displays steady or electronically sequenced light patterns creating brilliant visual effects. The use of an electronic controller for the light effects allows for other pre-programmed features to be included in the invention such as timers, motion sensors and audio sensors to allow the ornament to react to the installation environment. The illuminated ornament can be used for ornamental installations, such as holiday decoration, or as general and mood lighting installations.

This non-provisional patent claims reference to the provisional application No. 61/613,010, entitled “Illuminated Light Effect Ornament”, filed on Mar. 20, 2012.

### FIELD OF THE INVENTION

The present invention relates to decorative holiday and mood lighting. The invention is suitable for hanging installations as well as for display atop a stand or surface.

### BACKGROUND OF THE INVENTION

Illuminated ornaments have classically been used for seasonal decoration. Commonly ornaments are displayed hanging from a support structure in order to allow improved visibility. The addition of lights to ornaments increases their visibility in low light conditions while adding to the visual appeal.

Traditional illuminated ornaments employ steady state lighting techniques wherein the lights are typically on at all times. Thus, a substantial need exists for adding visual effects to illuminated ornaments, allowing the user to select between lighting displays with electronically controlled options such as light function, light color and light display timers.

### SUMMARY OF THE INVENTION

The present invention relates to an electronically controlled ornament which employs multiple light strings and an electronic controller in order to display lighting effects and other interactive light display features. More particularly, an ornament shell houses a plurality of light strings, each containing at least one light source, that are operatively coupled to an electronic controller. Power is supplied to the electronic controller via a power source which therein transmits preprogrammed lighting display signals to the light strings, illuminating the ornament. A user interface, which would commonly be a keypad or remote control, allows for selection between different lighting features. The light sources are preferably coupled to the exterior surface of the ornament by which at least a portion of the light sources extend outside the ornament.

Preferably, the ornament is spherical in shape, but any size or shape can be designed to suit the requirements of the installation. The ornament is preferably made in sections allowing simple assembly of the device and enclosure of the light strings and electronics. The requirement of the electronic controller allows for further interactive lighting effects which could be accomplished by integrating sensors into the electronics. Reaction to sound by means of an acoustic sensor and light by means of a photo sensor allow for numerous features and advantages over illuminated ornaments which are not electronically controllable.

Further, the preferred lighting elements on the light strings are light emitting diodes or “LEDs”. LEDs provide low energy consumption as well as design flexibility allowing for variable light brightness as well as multicolor capabilities.

### BRIEF DESCRIPTION OF THE DRAWINGS

FIG. 1 is a perspective view of an illuminated ornament assembly;

FIG. 2 is a perspective view of a portion of the inside of the illuminated ornament assembly shown in FIG. 1;

FIG. 3 is a perspective view of an alternate embodiment of the illuminated ornament assembly;

FIG. 4 is a perspective view of a portion of the inside of the illuminated ornament assembly shown in FIG. 3;

FIG. 5 is a perspective view of another alternate embodiment of the illuminated ornament assembly;

FIG. 6 is a perspective view of a portion of the inside of the illuminated ornament assembly shown in FIG. 5;

FIG. 7 is an exploded view of the preferred assembly features of the illuminated ornament assembly;

FIG. 8 is a perspective view of an alternate embodiment of the illuminated ornament housings containing secondary decorative members;

FIG. 9 is a perspective view of a secondary decorative member;

FIG. 10 is a perspective view of an LED housing assembly;

FIG. 11 depicts the use of a stand to display the illuminated ornament;

FIG. 12 is a perspective view of an alternate embodiment of the illuminated ornament assembly containing an internal power source;

FIG. 13 is a perspective view of a portion of the inside of the illuminated ornament assembly shown in FIG. 12.

### DETAILED DESCRIPTION OF THE PREFERRED EMBODIMENTS

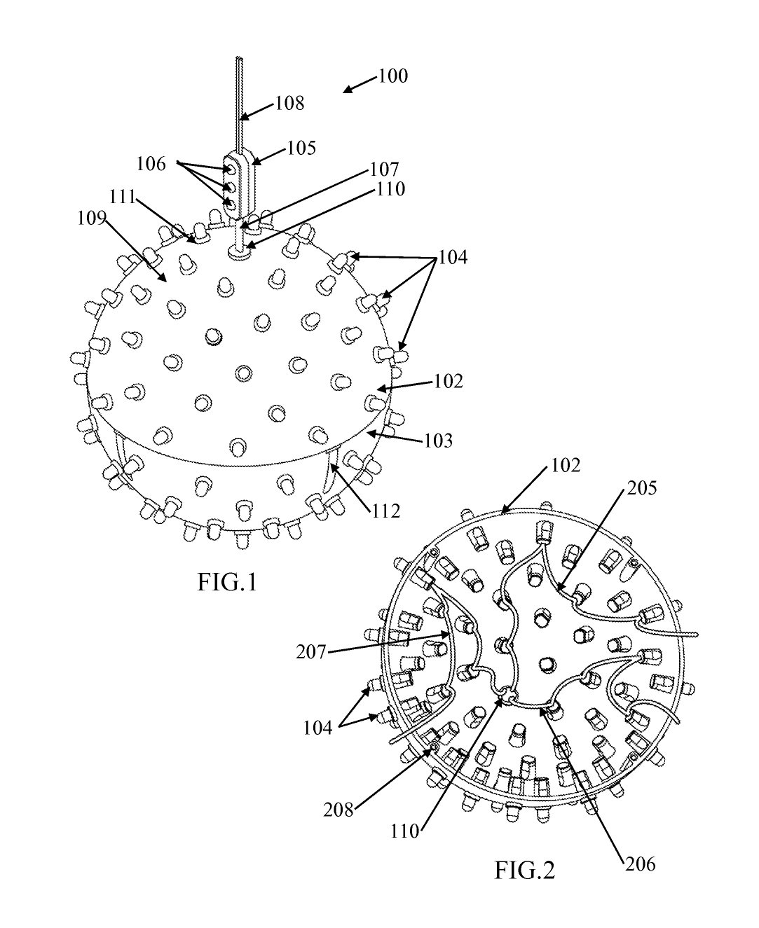

FIG. 1 depicts an illuminated ornament assembly 100. The illuminated ornament assembly 100 is comprised of two shell housings 102 and 103 that contain a plurality of lighting elements 104 which protrude at least partially through the exterior shell surface 109. The lighting elements 104 are preferably light emitting diodes (LEDs).

FIG. 2 is a perspective view of a portion of the inside of the illuminated ornament assembly 100 shown in FIG. 1. The LEDs 104 are connected in series on a plurality of light strings 205, 206 and 207 which enter the illuminated ornament assembly through an aperture 110. For purposes of illustration clarity, only a portion of the light string wires are shown, however the plurality of light strings 205, 206 and 207 continue from ornament shell housing 102 to the other ornament shell housing 103.

Power is supplied from an external source to the ornament through supply wires 108 into an electronic control interface assembly 105 referred to from this point on as a keypad. The keypad assembly 105 consists of selector buttons 106 and internal electronics, such as a printed circuit board (PCB), which is omitted from illustration for brevity as this circuitry is well known to those of ordinary skill. The selector buttons 106 allow for selection between preprogrammed lighting features controlled by the circuitry and software in the keypad assembly 105. A wiring bundle 107 exits the keypad assembly 105 and enters the shell housing 102 of the illuminated ornament assembly 100. The wiring bundle 107 consists of the wires required to supply power and electronic signals to the plurality of light strings 205, 206 and 207 contained inside the illuminated ornament assembly 100.

The LEDs 104 contained on the light strings 205, 206 and 207 are assembled to the shell housings 102 and 103 from the inside by operatively coupling to bulb apertures 111 which are spaced apart on the exterior shell surface 109 of the illuminated ornament assembly 100. Each of the light strings 205, 206 and 207 can be arranged randomly or in a specified pattern such that the LEDs 104 contained on the light strings protrude at least partially through the exterior shell surface 109.

Shell housings 102 and 103 are assembled using integrated features. Shell housing 103 contains hardware recesses 112 to receive screws while shell housing 102 contains screw bosses 208 to engage the screws and retain the two shell housings 102 and 103 together.

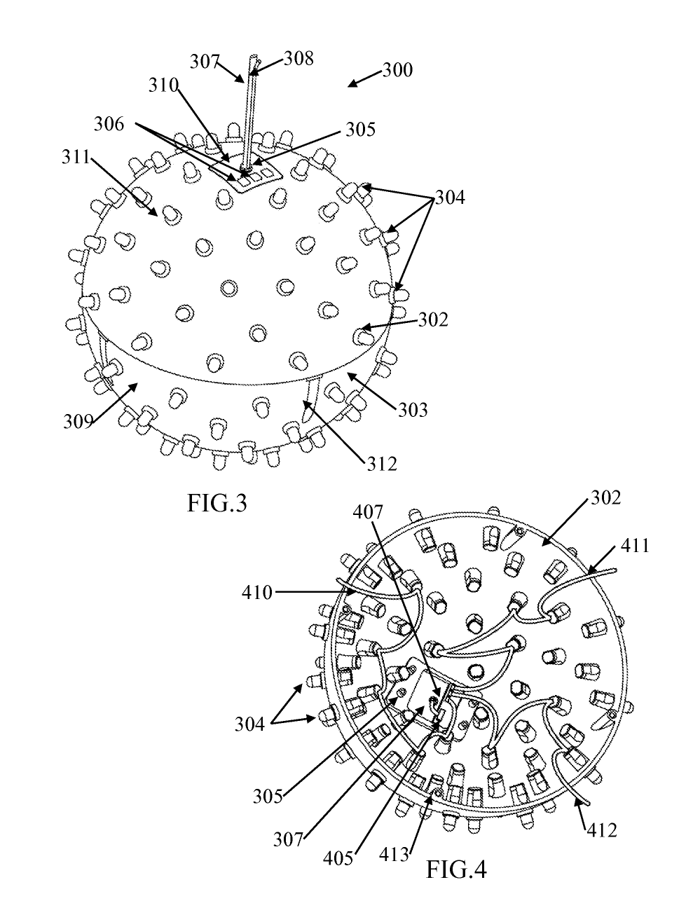

FIG. 3 depicts an illuminated ornament assembly 300. The'illuminated ornament assembly 300 is comprised of two shell housings 302 and 303 that contain a plurality of LEDs 304 which protrude at least partially through the exterior shell surface 309.

FIG. 4 is a perspective view of a portion of the inside of the illuminated ornament assembly 300 shown in FIG. 3. The LEDs 304 are connected in series on a plurality of light strings 410, 411 and 412 which are operatively coupled to a printed circuit board (PCB) 405. The PCB 405 is part of the integrated keypad assembly 305 which is operatively coupled to the shell housing 302. Power supply wires 307 enter the illuminated ornament 300 through the integrated keypad assembly 305 and are operatively coupled to the PCB 405. For purposes of illustration clarity only a portion of the light string wires are shown, however the plurality of light strings 410, 411 and 412 continue to the other ornament shell housing 303.

The keypad assembly 305 consists of a keypad housing 310, selector buttons 306 and the PCB 405. The selector buttons 306 allow for selection between preprogrammed lighting features controlled by the circuitry and software on the PCB and are accessible on the exterior of the illuminated ornament assembly 300. Light string terminals 407 electronically isolate the plurality of light strings 410, 411 and 412 from each other on the PCB 405 allowing for independent control and sequencing of each light string.

An additional hanging wire 308 is integrated and anchored into the keypad assembly 305. The hanging wire 308 relieves strain from the power supply wires 307 when the illuminated ornament 300 is displayed hanging from a structure.

The LEDs 304 contained on the light strings 410, 411 and 412 are assembled to the shell housings 302 and 303 from the inside by operatively coupling to bulb apertures 311 which are spaced apart on the exterior shell surface 309 of the illuminated ornament assembly 300. Each of the light strings 410, 411 and 412 can be arranged randomly or in a specified pattern such that the LEDs 304 contained on the light strings protrude at least partially through the exterior shell surface 309.

Shell housings 302 and 303 are assembled using integrated features. Shell housing 303 contains hardware recesses 312 to receive screws while shell housing 302 contains screw bosses 413 to engage the screws and retain the two shell housings 302 and 303 together.

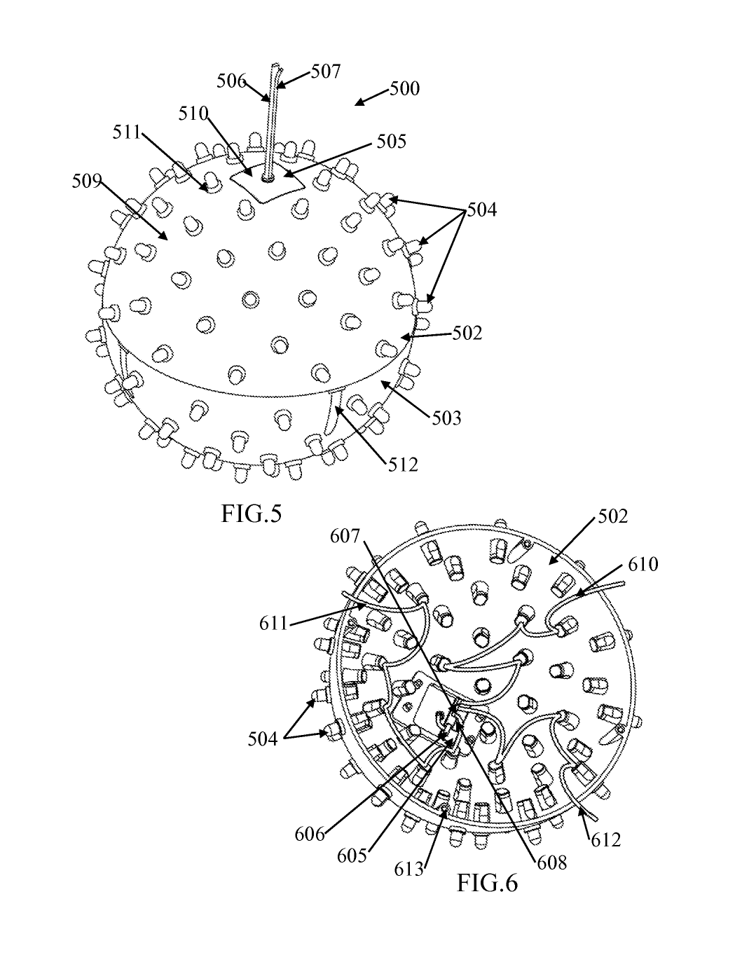

FIG. 5 depicts an illuminated ornament assembly 500. The illuminated ornament assembly 500 is comprised of two shell housings 502 and 503 that contain a plurality of LEDs 504 which protrude at least partially through the exterior shell surface 509.

FIG. 6 is a perspective view of a portion of the inside of the illuminated ornament assembly 500 shown in FIG. 5. The LEDs 504 are connected in series on a plurality of light strings 610, 611 and 612 which are operatively coupled to a PCB 605. The PCB 605 is part of the integrated electronics assembly 505 which is operatively coupled to the shell housing 502. Power supply wires 506 enter the illuminated ornament assembly 500 through the integrated electronics assembly 505 and are operatively coupled to the PCB 605. For purposes of illustration clarity only a portion of the light string wires are shown, however the plurality of light strings 610, 611 and 612 continue to the other ornament shell housing 503.

The electronics assembly 505 consists of a main housing 510 and a PCB 605. In this embodiment the PCB contains a plurality of light string terminals 607, a main power terminal 606 and a remote electronic receiver component 608. The remote receiver component 608 is capable of receiving and distributing commands to the light strings 610, 611 and 612 from an external remote control by means of the circuitry and software in the PCB. The remote control itself is not illustrated for brevity as this type of device is well known to those of ordinary skill. Light string terminals 607 electronically isolate the plurality of light strings 610, 611 and 612 from each other allowing for independent control and sequencing of each light string.

An additional hanging wire 507 is integrated and anchored into the electronics assembly 505. The hanging wire 507 relieves strain from the power supply wires 506 when the illuminated ornament 500 is displayed hanging from a structure.

The LEDs 504 contained on the light strings 610, 611 and 612 are assembled to the shell housings 502 and 503 from the inside by operatively coupling to bulb apertures 511 which are spaced apart on the exterior shell surface 509 of the illuminated ornament assembly 500. Each of the light strings 610, 611 and 612 can be arranged randomly or in a specified pattern such that the LEDs 504 contained on the light strings protrude at least partially through the exterior shell surface 509.

Shell housings 502 and 503 are assembled using integrated features. Shell housing 503 contains hardware recesses 512 to receive screws while shell housing 502 contains screw bosses 613 to engage the screws and retain the two shell housings 502 and 503 together.

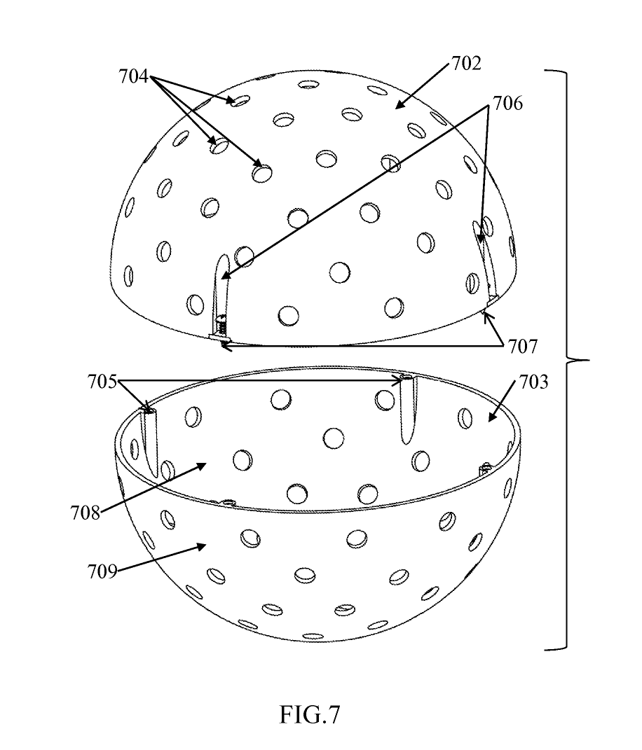

FIG. 7 is an exploded view depicting the preferred assembly features of the shell housings 702 and 703. Light bulb apertures 704 allow for installation of LEDs. The preferred method of LED retention is a snap-fit design wherein the LEDs are simply pressed into the interior shell surface 708. Hardware recesses 706 on shell housing 702 allow for screws 707 to be installed within the constraints of the exterior shell surface 709. The screws 707 are then advanced and retained in the screw bosses 705 found on shell housing 703 securing the assembly.

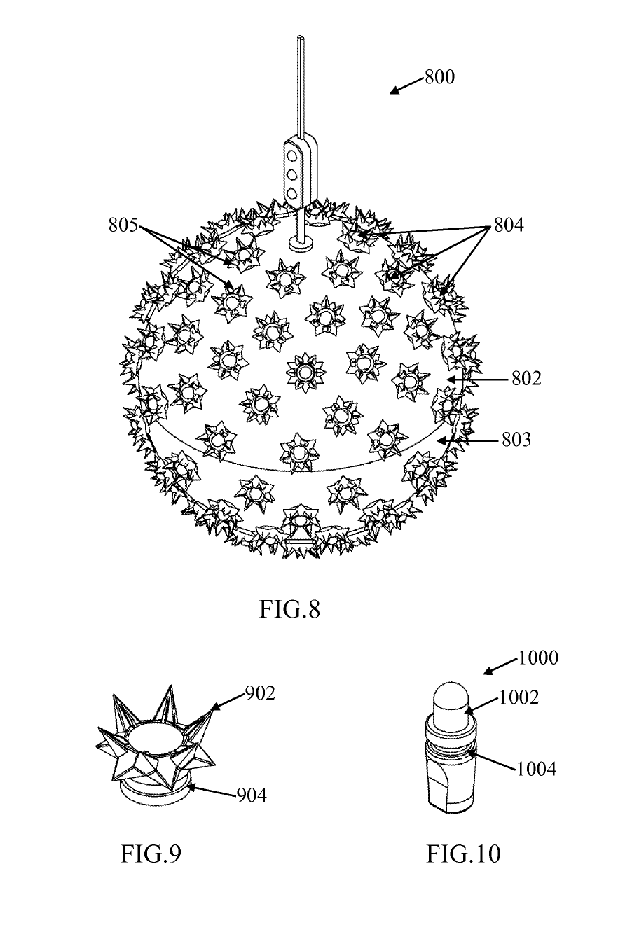

FIG. 8 is a perspective view of an alternate embodiment of the illuminated ornament assembly 800. The ornament is comprised of two shell housings 802 and 803 that contain a plurality of at least partially light transmissive secondary decorative members 805 operatively coupled to the outside of the shell housings 802 and 803. LEDs 804 operatively couple to the secondary decorative members 805 from the inside of the shell housings 802 and 803 wherein the LEDs 804 are at least partially visible on the outside of the ornament assembly 800 or light emitted from the LEDs 804 is visible through the at least partially light transmissive secondary decorative members 805.

FIG. 9 depicts a preferred design for the secondary decorative member 902. The secondary decorative member contains a recessed ring 904 in the design to allow snap fit retention onto a shell housing.

FIG. 10 depicts a preferred LED housing assembly 1000. The LED housing assembly 1000 is comprised of an LED 1002 captured inside an LED housing 1004. The LED housing contains a recessed ring suitable for snap-fit retention to the aforementioned shell housings or secondary decorative members.

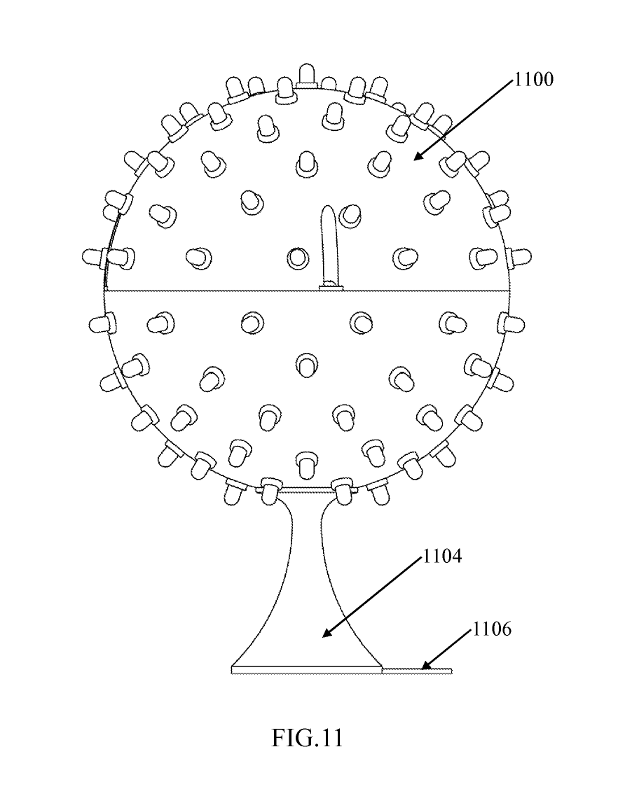

FIG. 11 depicts an illuminated ornament assembly 1100 wherein the illuminated ornament assembly 1100 sits atop a stand 1104. The stand 1104 houses the electrical supply cord 1106 and can be of many alternate designs.

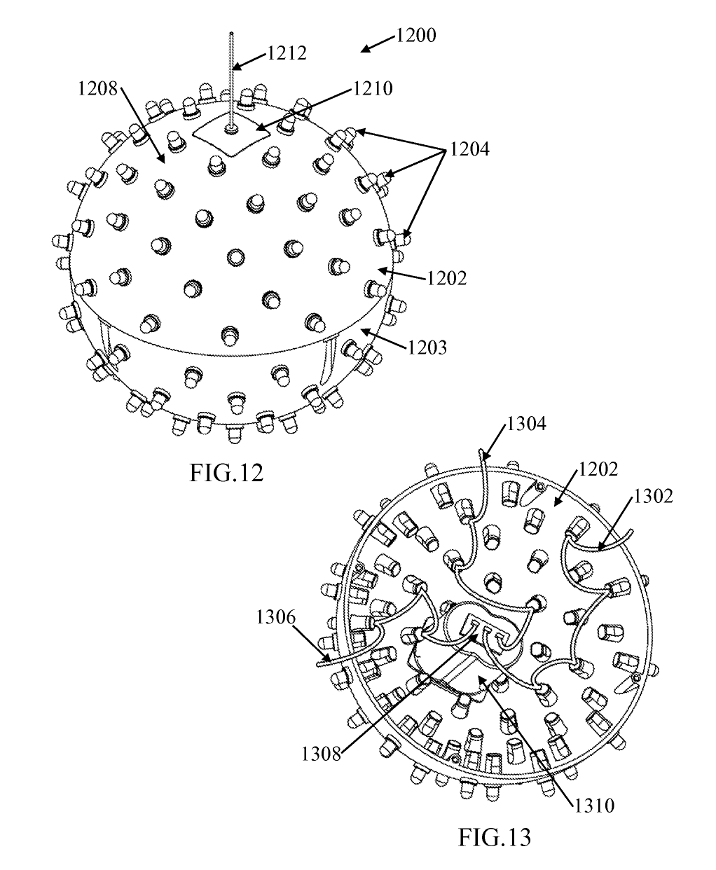

FIG. 12 depicts an illuminated ornament assembly 1200. The illuminated ornament assembly 1200 is comprised of two shell housings 1202 and 1203 that contain a plurality of LEDs 1204 which protrude at least partially through the exterior shell surface 1208.

FIG. 13 is a perspective view of a portion of the inside of the illuminated ornament assembly 1200 shown in FIG. 12. The LEDs 1204 are connected in series on a plurality of light strings 1302, 1304 and 1306 which are operatively coupled to a PCB 1308. The PCB 1308 is operatively coupled to an internal power supply 1310 referred to from this point as a battery pack. The battery pack 1310 and electronics are operatively coupled to the shell housing 1202. For purposes of illustration clarity only a portion of the light string wires are shown, however the plurality of light strings 1302, 1304 and 1306 continue to the other ornament shell housing 1203. A hanging wire 1212 is anchored into a battery pack housing 1210 for use when the illuminated ornament assembly 1200 is displayed hanging from a structure.

This illuminated ornament assembly 1200 design embodiment is assumed to be operated by remote control. Aforementioned functionality of remote electronics applies to this design, but is omitted for brevity. An illuminated ornament containing an internal power supply is easily adaptable to any user interface previously mentioned either integrated or remote operated.

Internal power supplies such as the battery pack 1310 in FIG. 13 are well known to those of ordinary skill. Specifics of the design details are omitted for brevity, but any type whether custom rechargeable batteries or standard disposable batteries of any type can be adapted to power the illuminated ornament assembly,

Assembly of any of the aforementioned components can be accomplished by other numerous methods employing integrated mechanical features or by use of adhesives, solder, potting processes, etc. It is assumed that shell housings are secured together with hardware and other components are operatively coupled to the shell housings by means of integrated snap-fit features. Electrical connections are assumed to be made by standard electrical connectors or by use of solder.

The foregoing description is for purposes of illustration. The true scope of the invention is set forth in the following claims.

What is claimed is:

1. An illuminated ornament, the ornament comprising:
a. a plurality of light strings, each comprised of multiple light bulbs, operatively coupled to an electronic controller; and
b. a shell configured to house the entirety of the light strings such that the light bulbs within the shell illuminate the ornament; and
c. a plurality of apertures defined on the exterior surface of the shell configured to receive a plurality of light bulbs from the light strings disposed within the shell; and
d. an electronic connection aperture on the exterior surface of the shell where power from an external source is transmitted to the electronic controller in order to distribute light and light effects to the light strings; and
e. an operator interface allowing for selection between electronic functions.

2. The illuminated ornament of claim 1 wherein the exterior surface apertures and bulb housings are configured in such a way to rigidly connect, securing the light bulbs in place.

3. The illuminated ornament of claim 1 further comprising a plurality of secondary decorative members operatively coupled to the exterior surface apertures by which the light bulbs are operatively coupled.

4. The illuminated ornament of claim 1 wherein the shell or controller further comprise a mechanism allowing a cord to be attached to the ornament for hanging.

5. The illuminated ornament of claim 1 wherein the shell further comprises a connection point mechanism allowing a secondary stand to be attached in order to display the ornament elevated from a given surface.

6. The illuminated ornament of claim 1 wherein the shell is comprised of multiple sections allowing for assembly.

7. The ornament of claim 6 wherein screw bosses and recesses are incorporated to allow for assembly of the multiple shell sections.

8. The illuminated ornament of claim 1 further comprising an electronic selection mechanism integrated into the shell in order to change between pre-programmed lighting features.

9. The illuminated ornament of claim 1 further comprising an electronic selection mechanism connected in series to the ornament, but outside of the shell in order to change between pre-programmed lighting features.

10. The illuminated ornament of claim 1 further comprising an electronic selection mechanism that communicates wirelessly to the electronic controller in order to change between pre-programmed lighting features.

11. The illuminated ornament of claim 1 wherein the shell is spherical in shape.

12. An illuminated ornament, the ornament comprising:
a. a plurality of light strings, each comprised of multiple light bulbs, operatively coupled to an electronic controller; and
b. a shell configured to house the entirety of the light strings and electronic controller such that the light bulbs within the shell illuminate the ornament; and
c. a plurality of apertures defined on the exterior surface of the shell configured to receive a plurality of light bulbs from the light strings disposed within the shell; and
d. an internal power source providing the energy required for the lights to function; and
e. a user interface allowing for selection between electronic functions.

13. The illuminated ornament of claim 12 wherein the exterior surface apertures and bulb housings are configured in such a way to rigidly connect, securing the light bulbs in place with the bulb protruding at least partially outside the exterior surface of the shell.

14. The illuminated ornament of claim 12 further comprising a plurality of secondary decorative members operatively coupled to the exterior surface apertures by which the light bulbs are operatively coupled.

15. The illuminated ornament of claim 12 wherein the shell further comprises a mechanism allowing a cord to be attached to the ornament for hanging.

16. The illuminated ornament of claim 12 wherein the shell further comprises a connection point mechanism allowing a secondary stand to be attached in order to display the ornament elevated from a given surface.

17. The illuminated ornament of claim 12 wherein the shell is comprised of multiple sections allowing for assembly.

18. The ornament of claim 17 wherein screw bosses are incorporated to allow for assembly of the multiple shell sections.

19. The illuminated ornament of claim 12 further comprising an electronic selection mechanism integrated into the shell in order to change between pre-programmed lighting features.

20. The illuminated ornament of claim 12 further comprising an electronic selection mechanism operatively coupled to the ornament, but outside of the shell in order to change between pre-programmed lighting features.

21. The illuminated ornament of claim 12 further comprising an electronic selection mechanism that communicates wirelessly to the electronic controller housed within the shell in order to change between pre-programmed lighting features.

22. The illuminated ornament of claim 14 wherein the shell is spherical in shape.
